(19) United States
(12) Patent Application Publication
(10) Pub. No.: US 2014/0278248 A1
(43) Pub. Date: Sep. 18, 2014

(54) Method and System for Facilitating Enterprise Appliance Administration Based on Detected Power Anomalies

(71) Applicants: Craig Thompson WHITTLE, Vancouver, WA (US); Andrew Rodney FERLITSCH, Camas, WA (US)

(72) Inventors: Craig Thompson WHITTLE, Vancouver, WA (US); Andrew Rodney FERLITSCH, Camas, WA (US)

(73) Assignee: Sharp Laboratories of America. Inc., Camas, WA (US)

(21) Appl. No.: 13/846,680

(22) Filed: Mar. 18, 2013

(51) Int. Cl. G01M 99/00

(52) U.S. Cl. CPC G01M 99/005
USPC 702/184; 702/183

(57) ABSTRACT

A method and system for administering enterprise appliances facilitates maintenance, procurement, deployment and security of enterprise appliances by taking targeted administrative actions in response to detected power anomalies experienced by such appliances. By using detected power anomalies as triggers for targeted administrative actions, rather than waiting for administrators to be notified of problems with enterprise appliances by workers or departments to which such appliances are assigned, problems with enterprise appliances are resolved more quickly and costs to the enterprise arising from such problems are reduced.

### BACKGROUND OF THE INVENTION

The present invention relates to administration of enterprise appliances and, more particularly, facilitating maintenance, procurement, deployment and security of enterprise appliances based on detected power anomalies experienced by such appliances.

Organizational workers use many different types of grid-powered appliances, such as computers, printers, copiers, scanners, fax machines, phones, lamps and refrigerators. Some of these appliances are assigned to individual workers or departments and others are kept as spares. An information technology (IT) department within these enterprises tracks appliance inventory.

Appliances assigned to individual workers or departments sometimes encounter problems. For example, appliances may fail or perform suboptimally, or may get relocated, stolen or discarded.

Ideally, if an appliance experiences a problem, the IT department is promptly notified by the worker or department to which the appliance is assigned. The IT department then generates a trouble ticket and, if necessary, dispatches a technician to the field to diagnose and solve the problem.

For various reasons, however, the IT department is not always notified of problems with appliances soon after the problems occur. Delaying notification of the IT department can be costly in several respects. One cost is reduced productivity of the worker or department to which the appliance is assigned until the appliance is repaired or replaced. Another cost is that if a replacement unit or parts must be ordered from an outside supplier, placement of the order and acquisition of the replacement unit or parts is delayed. Still another cost is that an appliance that is initially repairable may drift beyond repair after a time. Yet another cost is that if an appliance is relocated, stolen or discarded, and swift security measures are not taken, more appliances may suffer a similar fate.

### SUMMARY OF THE INVENTION

The present invention facilitates maintenance, procurement, deployment and security of enterprise appliances by taking targeted administrative actions in response to detected power anomalies experienced by such appliances. By using detected power anomalies as triggers for targeted administrative actions, rather than waiting for administrators to be notified of problems with enterprise appliances by workers or departments to which such appliances are assigned, problems with enterprise appliances are resolved more quickly and costs to the enterprise arising from such problems are reduced.

In one aspect of the invention, a method for facilitating administration of enterprise appliances comprises configuring in a memory a binding between a power outlet and an enterprise appliance connected to the outlet; monitoring a power draw on the outlet over time; detecting an anomaly in the power draw; associating the anomaly with the appliance by reference to the binding; and taking administrative action respecting the appliance in response to the anomaly.

In some embodiments, the step of taking action comprises taking a maintenance action respecting the appliance in response to determining that the monitored power draw deviates from a power profile for the appliance during a predetermined short term.

In some embodiments, the step of taking action comprises taking an inventory management action respecting the appliance in response to determining that the monitored power draw deviates from a power profile for the appliance during a predetermined long term.

In some embodiments, the step of taking action comprises taking an inventory management action respecting the appliance in response to determining that the monitored power draw persists below a predetermined in-service threshold over a predetermined service verification term.

In some embodiments, the step of taking action comprises taking an inventory management action respecting the appliance in response to determining that an amount of time the monitored power draw is above a predetermined in-service threshold during a predetermined use verification term is below a predetermined use threshold.

In some embodiments, the method further comprises identifying and removing from the memory a conflicting binding involving at least one of the outlet or the appliance.

In some embodiments, the step of taking action comprises selecting an administrative action from a plurality of candidate administrative actions based on a severity of a deviation of the monitored power draw from a power profile for the appliance.

In some embodiments, the method further comprises verifying that the administrative action is not redundant before taking the action.

In some embodiments, the configuring step comprises detecting connectivity of the appliance to the outlet; querying the appliance through the outlet for a media access control (MAC) address of the appliance; and associating in the memory an identifier of the outlet and the MAC address.

In some embodiments, the configuring step further comprises receiving an association between an identifier of the outlet and an Internet Protocol (IP) address of the appliance; querying the appliance on a TCP/IP network using the IP address for a MAC address of the appliance; receiving from the appliance on the TCP/IP network the MAC address; and associating in the memory the identifier of the outlet and the MAC address.

In some embodiments, the inventory management action comprises a procurement action.

In some embodiments, the inventory management action comprises a replacement action.

In some embodiments, the inventory management action comprises a redeployment action.

In some embodiments, the inventory management action comprises a security action.

In some embodiments, the administrative action comprises scheduling an event.

In some embodiments, the administrative action comprises outputting an alert.

In another aspect of the invention, a system for administering enterprise appliances comprises a status and control unit having a power outlet; and a power manager communicatively coupled with the status and control unit and having an associated memory, wherein the status and control unit and the power manager are configured to interoperate to monitor a power draw on the outlet over time, and wherein the power manager is further configured to detect an anomaly in the power draw, associate the anomaly with an enterprise appliance by reference to a binding between the outlet and the appliance configured in the memory and take administrative action respecting the appliance in response to the anomaly.

In some embodiments, the power manager is configured to take a maintenance action respecting the appliance in response to determining that the monitored power draw deviates from a power profile for the appliance during a predetermined short term and take an inventory management action respecting the appliance in response to determining that the monitored power draw deviates from the power profile during a predetermined long term.

In some embodiments, the power manager is configured to take an inventory management action respecting the appliance in response to determining that the monitored power draw persists below a predetermined in-service threshold for a predetermined service verification term.

In some embodiments, the power manager is configured to take an inventory management action respecting the appliance in response to determining that an amount of time the monitored power draw is above a predetermined in-service threshold during a predetermined use verification term is below a predetermined use threshold.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a system for administering enterprise appliances.

FIG. 2 shows a status and control unit.

FIG. 3 shows a power manager.

FIG. 4 is a plot showing power-time curves for an enterprise appliance.

FIG. 5 is a table showing data points used for constructing a power profile for an enterprise appliance.

FIG. 6 is a table showing data points used for comparing a power profile for an enterprise appliance with a monitored power draw by the appliance to identify deviations from profile.

FIG. 7 shows a method for taking a maintenance action respecting an enterprise appliance based on a detected short-term power anomaly experienced by the appliance.

FIG. 8 shows a method for configuring a binding between a power outlet and an enterprise appliance connected to the outlet in some embodiments of the invention.

FIG. 9 shows a method for configuring a binding between a power outlet and an enterprise appliance connected to the outlet in other embodiments of the invention.

FIG. 10 shows a method for taking a inventory management action respecting an enterprise appliance based on a detected long-term power anomaly experienced by the appliance.

FIG. 11 shows a method for taking an inventory management action respecting an enterprise appliance based on a detected out-of-service power anomaly experienced by the appliance.

FIG. 12 shows a method for taking an inventory management action respecting an enterprise appliance based on a detected underutilization power anomaly experienced by the appliance.

### DETAILED DESCRIPTION OF A PREFERRED EMBODIMENT

FIG. 1 shows a system 10 for administering enterprise appliances in some embodiments of the invention. System 10 includes a power manager 110 communicatively coupled with status and control units 120, 130, 140, a maintenance console 150 and an inventory management console 160. Manager 110 and units 120, 130, 140 communicate using one or more wired (e.g., Ethernet) and/or wireless (e.g., Wi-Fi, ZigBee) protocols. Manager 110 and consoles 150, 160 communicate using one or more wired and/or wireless protocols. In some embodiments, manager 110 and consoles 150, 160 communicate remotely over the Internet.

Units 120, 130, 140 are installed at enterprise workspaces 126, 136, 146, such as offices, cubicles or conference rooms at business premises. Units 120, 130, 140 supply and monitor power to enterprise appliances 122, 124, 132, 134, 142, 144. In the illustrated embodiment, unit 120 powers and monitors appliances 122, 124, unit 130 powers and monitors appliances 132, 134 and unit 140 powers and monitors appliances 142, 144. Appliances 122, 124, 132, 134, 142, 144 include various types of devices that have power plugs for plugging-in to outlets and receiving remotely sourced power, such as audio cassette players, cell phones, coffee makers, calculators, clocks, compact disc players, video conferencing equipment, copy machines, desktop computers, digital video disc players, fans, fax machines, lamps, landline phones, lights, microphones, microwave ovens, multifunction peripherals (MFP), notebook computers, overhead projectors, pencil sharpeners, printers, radios, refrigerators, scanners, smart phones, space heaters, speakers, televisions tablet computers and video cassette players. Of course, these specifically identified appliance types, as well as the number of status and control units and appliances shown in system 10, are purely exemplary and may vary in different embodiments.

FIG. 2 shows a status and control unit 200 in some embodiments of the invention. Unit 200 has a power controller 220 operatively coupled between a power sensor 210, a network interface 230, a power circuit 240 and a memory 250. Unit 200 also includes a power outlet 242 (e.g., smart plug) operatively coupled with circuit 240. Circuit 240 has a power source 248 for supplying power via outlet 242 to an enterprise appliance 202 that is plugged-in to outlet 242 using a power plug tethered to or otherwise exposed on appliance 202.

In operation, sensor 210 senses the voltage on circuit 240 caused by the power draw by appliance 202 on outlet 242. Sensor 210 includes a voltage divider and a current-sensing resistor. The voltage divider reduces peak-to-peak voltage (e.g., 170 V) on circuit 240 to a level appropriate for sampling and measuring by controller 220. The current-sensing resistor is a low resistance (e.g., 0.2 ohm) resister inserted at a break in the neutral line that creates a small voltage drop for sampling by controller 220. Sensor 210 also includes an activity sensor that senses when an appliance plugged-in to circuit 240 is activated.

Controller 220 generates, by sampling sensor 210, power parameters from which the power draw by appliance 202 on outlet 242 can be estimated. The sampling rate may be variable. For example, a high sampling rate may be used when appliance 202 is first activated to provide ample measurements for establishing an initial power profile for appliance 202, after which the sampling rate may be reduced. Controller 220 samples the voltage drop across the current-sensing resister on sensor 210 and generates current measurements (I) for circuit 240 from the sampled voltage drop and known resistance. Controller 220 samples the divided voltage on sensor 210 and generates voltage measurements (V) for circuit 240 based on the sample and the known level of division. Controller 220 estimates the power draw (P) by appliance 202 on outlet 242 using the power parameter measurements (e.g., P=V*I). Controller 220 may also measure the power factor. Controller 220 time-stamps power draw estimates and stores them in memory 250.

Controller 220 also generates and transmits status messages to manager 110 via interface 230. Status messages include an outlet identifier (Outlet ID) uniquely identifying outlet 242 within system 10 and a message type identifier. The Outlet ID of outlet 242 may be prefabricated into unit 200 or configured by an administrator or worker during or after installation of unit 200. In the former case, the Outlet ID may be burned into a predetermined read-only memory (ROM) address within memory 250. In the latter case, the Outlet ID may be configured at a predetermined programmable ROM (e.g., ePROM) address within memory 250. One type of status message notifies manager 110 when an appliance has been activated on outlet 242 for the first time. Another type of status message contains a unique identifier of an appliance (Appliance ID) connected to outlet 242. Yet another type of status message contains one or more time-stamped power draw estimates for an appliance connected to outlet 242.

Controller 220 also processes administrative action messages received from manager 110 via interface 230 and, if indicated, controls the power state of appliance 202 in response to administrative action messages. For example, in response to receiving an administrative action message indicating to turn-off appliance 202, controller 220 may change the state of a solid state relay switch 246 and render outlet 242 inoperative. Conversely, in response to receiving a message indicating to reinstate operability of appliance 202, controller 220 may change the state of switch 246 and return outlet 242 to an operative state. Such administrative action messages include the Outlet ID of the outlet that is the target of administrative action.

In some embodiments, controller 220 is implemented in an ATmega128 microcontroller integrated circuit marketed by Atmel Corporation and is isolated from the high voltage of circuit 240 using opto-isolators.

While unit 200 is shown to include one circuit 240, one outlet 242 and one switch 246, the number of circuits, outlets and switches on a single status and control unit may vary and will often be more than one. Moreover, a status and control unit may have a different configuration that enables the unit to make additional or different types of changes to the power state of appliances in response to administrative action messages, such as dimming an appliance, placing an appliance into a standby mode, placing an appliance into a hibernation mode and/or effecting a thermostatic change on an appliance.

In some embodiments, unit 200 has proximity sensors [e.g., ultrasonic, radio frequency identification (RFID), sound, infrared, Bluetooth signal strength, etc.] that detect whether the worker in whose workspace unit 200 is installed is present at the workspace and communicate this to manager 110 using status messages. This allows manager 110 to take the worker's presence into account when determining administrative actions.

FIG. 3 shows manager 110 in some embodiments of the invention. Manager 110 has a processing module 320 operatively coupled between one or more network interfaces 310 and a memory 330. Manager 110 communicates with units 120, 130, 140 and consoles 150, 160 via network interfaces 310. In some embodiments, processing module 320 is a microprocessor that performs functions described herein as being performed by manager 110 by executing software programs stored in memory 330. In other embodiments, one or more of elements of processing module 320 or a portion thereof are implemented by a microcontroller or custom circuitry. For example, processing module 320 may include a single-board computer running an embedded Linux operating system coupled via a universal serial bus (USB) interface with a microcontroller daughter board. In addition to storing software programs executable by processing module 320, memory 330 maintains several databases, including an outlet-appliance bindings database, an appliance power draw measurement database, an appliance profile database and an administrative action database.

The outlet-appliance bindings database stores bindings between Outlet IDs and Appliance IDs. Each binding is a database entry associating an Outlet ID of a power outlet with one or more Appliance IDs of an enterprise appliance that is (or was) connected to the outlet. Outlet IDs uniquely identify outlets within system 10. Appliance IDs uniquely identify appliances within system 10. Appliance IDs may be MAC addresses or enterprise asset tags of appliances, for example. Appliance IDs also may include IP addresses of appliances if known.

The appliance power draw measurement database stores power draw estimates respecting appliances received from status and control units 120, 130, 140. Each entry includes an Outlet ID of an outlet to which a power draw estimate pertains, a start of measurement timestamp, a measurement duration and a measured power draw on the outlet. The database may have a separate table for each outlet containing a predetermined number of entries. When a table for an outlet is full and there is a new measurement to store, the oldest entry is overwritten. Entries in power draw measurement database are arranged with Outlet IDs as primary keys. In some embodiments, consecutive entries are consolidated to conserve table space by overwriting the timestamp field in a first entry being consolidated with the timestamp of the oldest entry being consolidated, overwriting the measurement duration in the first entry with the combined duration of the entries being consolidated and overwriting the measured power draw field of the first entry with the average power draw from the entries being consolidated.

The appliance profile database stores profiles for appliances. Each entry includes an Appliance ID of an appliance to which the profile pertains and profile data. Profile data for an entry may include, for example, a profile type (e.g., full power, standby, sleep, hibernation, out-of-service, underutilization, etc.) and profile parameters (e.g., maximum and minimum thresholds, in-service threshold, use threshold, service verification term, use verification term, etc.).

The administrative action database stores administrative actions in association with profiles and severities to which administrative actions apply. Each entry includes a profile type and an out-of-profile deviation (e.g., 0-10% out-of-profile, >10% out-of-profile, etc.) to which an administrative action applies, an administrative action content type (e.g., maintenance, procurement, deployment, security, etc.) and an administrative action format type (e.g., mild alert, severe alert, low priority scheduling, high priority scheduling, etc.).

In operation, manager 110 facilitates administration of enterprise appliances by taking targeted administrative actions in response to detected power anomalies experienced by such appliances. Consider first FIG. 4, which is a plot 400 of power-time curves for a dual power mode enterprise appliance that can help illustrate how manager 110 interoperates with unit 200 to facilitate administration of appliances. At the outset, a system administrator or worker plugs appliance 202 into outlet 242 and appliance 202 is activated. During a configuration phase, appliance 202 proceeds to consume power at a variable rate shown in a power-time curve 410. After the configuration phase, based on the power consumed by appliance 202 during the configuration phase, manager 110 configures a power profile for appliance 202 including a maximum threshold 420 and a minimum threshold 430 bounding an expected power draw range for appliance 202 while appliance 202 is operating normally in full power mode. Additionally, manager 110 configures a second power profile for appliance 202 including a maximum threshold 440 and a second minimum threshold 450 bounding an expected power draw range for appliance 202 while operating normally in a reduced power mode (e.g., sleep mode). Thresholds 420, 430, 440, 450 are set based on the power consumption by appliance 202 during the configuration phase and may take into account other factors, such as the work schedule of the worker to whom appliance 202 is assigned (e.g., determined from calendaring software) and seasonal variation. Alternatively, thresholds 420, 430, 440, 450 may be configured on manager 110 by a system administrator. In either event, the power profiles are stored in memory 330. Once the power profiles for appliance 202 have been configured, manager 110 monitors the power draw by appliance 202 over time for conformance with the configured power profiles for appliance 202 using estimates received from unit 200 of the actual power draw by appliance 202. When the power draw by appliance 202 drifts out-of-profile after a time, as illustrated by power-time curve 440, manager 110 detects a power anomaly and takes administrative action. The power drift reflected in power-time curve 440, in which the power draw by appliance 202 while operating in full power mode falls below profile, may be caused by, for example, a motherboard on appliance 202 that has become defective or a power supply on appliance 202 that has begun to generate power below tolerance.

Now consider FIG. 5, which is a table 500 showing exemplary data points used by manager 110 during the configuration phase for constructing a full power mode power profile for appliance 202. In the illustrated example, manager 110 configures maximum and minimum thresholds for appliance 202 in a full power mode once appliance 202 achieves a steady state after activation. Manager 110 determines when the steady state has been achieved using a five-sample moving average of power draw estimates received from unit 200 with a twenty percent change tolerance. Thus, one second after activation, manager 110 sets a steady state flag to FALSE. Five seconds after activation, manager 110 begins to compute the moving average of the power draw by appliance 202 (51.9 W). Six seconds after activation, manager 110 begins to compute the percent change in the moving average of the power draw relative to the previous second (42.9%). Since the percent change is greater than twenty percent, the steady state flag remains FALSE. However, eight seconds after activation, the percent change (12.22%) drops below twenty percent, and manager 110 sets the steady state flag to TRUE and begins dynamically adjusting the maximum and minimum thresholds to the highest and lowest power draw estimates received. After several consecutive seconds where the steady state flag remains TRUE (e.g., at t=16.0 seconds), manager 110 freezes the maximum and minimum thresholds for the full power mode at the current threshold values (152.3 W, 113.9 W). By way of example, manager 110 may fix the maximum and minimum thresholds after a predetermined number of consecutive steady state estimates or when the moving average starts to decline after a minimum number of consecutive steady state measurements. Manager 110 may repeat the above process over multiple usage cycles and construct a full power mode power profile for appliance 202 by averaging the maximum and minimum thresholds over the multiple usage cycles.

Continuing the above example, FIG. 6 is a table 600 showing data points used after the configuration phase for comparing the full power mode power profile for appliance 202 with the monitored power draw by appliance 202 to detect deviations from profile. Starting with the estimate eight seconds after activation, manager 110 begins to compare the monitored power draw (91.1 W) against the configured maximum and minimum thresholds (152.3 W, 113.9 W). Since the monitored power draw is below the minimum threshold, the in-profile flag is set to FALSE. However, the power draw is not conclusively determined to be out-of-profile profile since the threshold violation has not yet persisted for a predetermined minimum number of consecutive seconds (e.g., five seconds). By the estimate eleven seconds after activation, the power draw has risen above the minimum threshold and the in-profile flag is set to TRUE. After several more estimates where the in-profile flag remains TRUE, the power draw once again drops below the minimum threshold (eighteen seconds after activation) and the in-profile flag is reset to FALSE. This time, however, the out-of-profile state of appliance 202 persists for a predetermined minimum time (e.g., five seconds), causing manager 110 to detect a short-term power anomaly and take administrative action. Of course, in other examples, manager 110 may require an out-of-profile state to persist for longer than five seconds (e.g., five minutes) or require an out-of-profile state to be detected in multiple instances before detecting a short-term power anomaly and taking administrative action.

FIGS. 7 and 10-12 illustrate different methods for facilitating administration of enterprise appliances by taking targeted administrative actions in response to detected power anomalies. These methods are realized through cooperative action between unit 200, which collects information from appliance 202 via outlet 242 and transmits status messages containing the information to manager 110, and manager 110, which stores, retrieves and manipulates the information programmatically to identify power irregularities and take targeted administrative actions.

Turning first to FIG. 7 a method for taking a maintenance action respecting appliance 202 based on a detected short-term power anomaly experienced by appliance 202 is shown. Maintenance actions taken in response to short-term power anomalies may include, for example, issuing trouble alerts to maintenance personnel and automated scheduling of inspections, diagnostic tests, repair and replacement of appliances and components. At the outset, appliance 202 is bound with outlet 242 to which appliance 202 is connected by configuring an association in memory 330 between appliance 202 and outlet 242 (705). Next, manager 110 checks for and removes from memory 330 any conflicting bindings (710). A conflicting binding may exist in memory 330 if, for example, another appliance that was previously connected to outlet 242 was removed without updating outlet-appliance bindings database or appliance 202 was previously connected to another outlet and removed without updating outlet-appliance bindings database. If a conflicting binding is detected, manager 110 transmits a removal alert respecting the removed appliance to inventory management console 160 whereon the removal alert is displayed. Next, unit 200 measures the power draw on outlet 242 during a configuration phase of predetermined duration (715). Next, manager 110 constructs a power profile for appliance 202 based on the measured power draw and stores the power profile in memory 330 (720). Manager 110 associates the measured power draw on outlet 242 with appliance 202 by reference to the configured binding between outlet 242 and appliance 202 in memory 330. Next, manager 110 continually monitors the power draw on outlet 242 (725) until the power draw deviates from the power profile over a predetermined short term (730). When the power draw deviates from profile over the predetermined short term, manager 110 consults memory 330 and selects a maintenance action for appliance 202 from among multiple candidate maintenance actions based on the severity of the deviation from profile (735). For example, if the deviation from profile is less than a predetermined percentage (e.g., 10%), manager 110 may transmit a mild alert to maintenance console 150. On the other hand, if the deviation from profile is greater than a predetermined percentage (e.g., 30%), manager 110 may transmit a severe alert to maintenance console 150. As another example, if the deviation from profile is below a predetermined percentage, manager 110 may automatically schedule a maintenance appointment for appliance 202 in a maintenance calendar kept on maintenance console 150 on a low priority basis (e.g., thirty days out). On the other hand, if the deviation from profile is greater than a predetermined percentage, manager 110 may automatically schedule a maintenance appointment for appliance 202 in the maintenance calendar on a high priority basis (e.g., first available opening). Naturally, additional or different maintenance actions are possible, such as transmitting a maintenance alert to a worker or department to which appliance 202 is assigned. Manager 110 may transmit maintenance alerts to system administrators, workers or departments by email, text message, within an application, or by other means. Moreover, before taking a selected maintenance action, manager 110 determines whether taking the action would be redundant (740). A selected maintenance action may be deemed redundant if, for example, the same or a similar maintenance action was taken within a predetermined period (e.g., within the last month, week, day, etc.). If the selected maintenance action is not deemed redundant, manager 110 takes the selected maintenance action (745).

Referring momentarily to FIG. 8, a first method for configuring a binding between outlet 242 and appliance 202 is shown. In this method, the power line between outlet 242 and appliance 202 doubles as a communication link operating in accordance with a protocol such as Home Plug Alliance (HPA) v.1.0 or Power over Ethernet (PoE). Unit 200 and appliance 202 are HPA or PoE compliant and appliance 202 has a configured MAC address. Unit 200 first discovers that appliance 202 is connected to outlet 242 (805). Unit 200 may discover appliance 202 by detecting connectivity on outlet 242 or through receipt of a notification from manager 110 that an appliance is connected to outlet 242. Unit 200 then queries appliance 202 for its MAC address via outlet 242 (810). Appliance 202 then responds to the query by providing its MAC address via outlet 242 and unit 200 transmits a status message containing the associated Outlet ID and MAC address to manager 110, which configures the association in memory 330 (815).

FIG. 9 shows a second method for configuring a binding between outlet 242 and appliance 202. In this method, appliance 202 is a TCP/IP networking device having a configured MAC address. A system administrator or worker to whom appliance 202 is assigned registers an association between the IP address of appliance 202 and Outlet ID of outlet 242 with power manager 110 (905). Registration may be achieved through inputs on inventory management console 160 or using another network computing device. Manager 110 then queries appliance 202 for the MAC address by pinging the IP address over a TCP/IP network (910). Appliance 202 responds to the ping message over the TCP/IP network and provides MAC address to manager 110 (915) whereupon manager 110 configures an association between the Outlet ID and the MAC address in memory 330 (920).

In still other embodiments, manager 110 transmits a MAC address query that flows transparently through unit 200 and over the power line between outlet 242 and appliance 202, which doubles as a communication link. Appliance 202 transmits a response containing its MAC address that flows transparently through unit 200 and back to manager 110.

In still other embodiments, a system administrator may bind outlet 242 and appliance 202 through inputs on a registration web page. For example, a system administrator using inventory management console 160 or another network computing device may browse to a registration page using a standard web browser and enter the Outlet ID of outlet 242 and a MAC address or another asset tag that is uniquely associated with appliance 202, whereupon manager 110 configures an association between the Outlet ID and the MAC address or other asset tag in memory 330.

Turning now to FIG. 10, a method for taking an inventory management action respecting appliance 202 based on a detected long-term power anomaly experienced by appliance 202 is shown. Inventory management actions taken in response to long-term power anomalies may include, for example, inventory change requests addressed to inventory management personnel and automated scheduling of procurement, replacement and redeployment of appliances and components. At the outset, appliance 202 is bound with outlet 242 to which appliance 202 is connected by configuring an association in memory 330 between appliance 202 and outlet 242 (1005). Next, manager 110 checks for and removes from memory 330 any conflicting bindings and issues removal alerts as needed (1010). Next, unit 200 measures the power draw on outlet 242 during a configuration phase of predetermined duration (1015). Next, manager 110 constructs a power profile for appliance 202 based on the measured power draw and stores the power profile in memory 330 (1020). Manager 110 associates the measured power draw on outlet 242 with appliance 202 by reference to the configured binding between outlet 242 and appliance 202 in memory 330. Next, manager 110 continually monitors the power draw on outlet 242 (1025) until the power draw deviates from the power profile over a predetermined long term (e.g., a week or longer) (1030). When the power draw deviates from profile over the predetermined long term, manager 110 consults memory 330 and selects an inventory management action for appliance 202 from among multiple candidate inventory management actions based on the severity of the deviation (1035). For example, if the deviation from profile is less than a predetermined percentage, manager 110 may transmit a mild alert to inventory management console 150. On the other hand, if the deviation from profile is greater than a predetermined percentage, manager 110 may transmit a severe alert to inventory management console 150. As another example, if the deviation from profile is below a predetermined percentage, manager 110 may schedule an inventory management event for appliance 202 in an inventory management calendar kept on inventory management console 150 on a low priority basis (e.g., thirty days out). On the other hand, if the deviation from profile is greater than the predetermined percentage, manager 110 may schedule an inventory management event for appliance 202 in the inventory management calendar on a high priority basis (e.g., first available opening). Other inventory management actions are possible and manager 110 may transmit inventory management by email, text message, within an application or by other means. Before taking a selected inventory management action, manager 110 determines whether taking the action would be redundant (1040). Taking a selected inventory management action may be deemed redundant if, for example, the same or a similar inventory management action was taken recently. If the selected inventory management action is not considered redundant, manager 110 takes the selected inventory management action (1045).

In some embodiments, the methods of FIG. 7 and FIG. 10 work in tandem, such that a maintenance action is taken respecting appliance 202 in response to a deviation from a power profile for appliance 202 over a predetermined short term and an inventory management action is taken respecting appliance 202 if the deviation from the power profile persists over a predetermined long term.

FIG. 11 shows a method for taking an inventory management action respecting appliance 202 based on a detected out-of-service power anomaly experienced by appliance 202. This method is designed to detect whether appliance 202 is no longer in-service at outlet 242, due to failure, relocation, removal, discard or theft. Inventory management actions taken in response to out-of-service power anomalies may include, for example, inventory change requests addressed to inventory management personnel, automated scheduling of procurement, replacement and redeployment of appliances and components and security alerts. At the outset, appliance 202 is bound with outlet 242 to which appliance 202 is connected by configuring an association in memory 330 between appliance 202 and outlet 242 (1105). Next, manager 110 checks for and removes from memory 330 any conflicting bindings and issued removal alerts as needed (1110). Next, manager 110 monitors the power draw on outlet 242 for at least a service verification term (1115). The service verification term is configured by a system administrator using inventory management console 160 or another network computing device and is selected to be long enough that appliance 202, if still in service at outlet 242, would be expected to be used at some point during the term (e.g., thirty days). Next, manager 110 compares the power draw at each measured point during the service verification term with an in-service threshold (1120). The in-service threshold is set to a power level above which appliance 202 can be safely presumed to be drawing power from outlet 242. By way of example, the in-service threshold may be set to a value between zero and the minimum threshold of the power profile for appliance 202 when in a reduced power mode. The in-service threshold may be configured by manager 110 programmatically or by a system administrator using inventory management console 160 or another network computing device. If the power draw at no measured point during the service verification term exceeds the in-service threshold, manager 110 takes an inventory management action respecting appliance 202 (1125). For example, manager 110 may flag appliance 202 as out-of-service in memory 330 and send an out-of-service or missing appliance alert respecting appliance 202 to inventory management console 160.

FIG. 12 shows a method for taking an inventory management action respecting appliance 202 based on a detected underutilization power anomaly experienced by appliance 202. This method is designed to detect whether appliance 202 drawing power from outlet 242 is underutilized (and might be redeployed within system 10 for more efficient use). Inventory management actions taken in response to underutilization power anomalies may include, for example, issuing redeployment requests to inventory management personnel and/or automated scheduling of redeployment. At the outset, appliance 202 is bound with outlet 242 to which appliance 202 is connected by configuring an association in memory 330 between appliance 202 and outlet 242 (1205). Next, manager 110 checks for and removes from memory 330 any conflicting bindings and issues removal alerts as needed (1210). Next, manager 110 monitors the power draw on outlet 242 for a use verification term (1215). The use verification term is configured by a system administrator using inventory management console 160 or another network computing device and is selected to be long enough that fractional utilization of appliance 202 can be determined accurately (e.g., thirty days). Next, manager 110 compares the power draw at each measured point during the use verification term with an in-service threshold (1220). The in-service threshold is set to a power level above which appliance 202 can be safely presumed to be drawing power from outlet 242. By way of example, the in-service threshold may be set to a value between zero and the minimum threshold of the power profile for appliance 202 when in a reduced power mode. The in-service threshold may be configured by manager 110 programmatically or by a system administrator using inventory management console 160 or another network computing device. If during the use verification term the time spent above the in-service threshold does not exceed a use threshold (which is also configured by a system administrator using inventory management console 160 or another network computing device), manager 110 takes an inventory management action respecting appliance 202 (1225). For example, manager 110 may flag appliance 202 as underutilized in memory 330 and send an underutilization alert respecting appliance 202 to inventory management console 160.

It will be appreciated by those of ordinary skill in the art that the invention can be embodied in other specific forms without departing from the spirit or essential character hereof. The present description is thus considered in all respects to be illustrative and not restrictive. The scope of the invention is indicated by the appended claims, and all changes that come with in the meaning and range of equivalents thereof are intended to be embraced therein.

What is claimed is:

1. A method for facilitating administration of enterprise appliances, comprising:
configuring in a memory a binding between a power outlet and an enterprise appliance connected to the outlet;
monitoring a power draw on the outlet over time;
detecting an anomaly in the power draw;
associating the anomaly with the appliance by reference to the binding; and
taking administrative action respecting the appliance in response to the anomaly.

2. The method of claim 1, wherein the step of taking action comprises taking a maintenance action respecting the appliance in response to determining that the monitored power draw deviates from a power profile for the appliance during a predetermined short term.

3. The method of claim 1, wherein the step of taking action comprises taking an inventory management action respecting the appliance in response to determining that the monitored power draw deviates from a power profile for the appliance during a predetermined long term.

4. The method of claim 1, wherein the step of taking action comprises taking an inventory management action respecting the appliance in response to determining that the monitored power draw persists below a predetermined in-service threshold over a predetermined service verification term.

5. The method of claim 1, wherein the step of taking action comprises taking an inventory management action respecting the appliance in response to determining that an amount of time the monitored power draw is above a predetermined in-service threshold during a predetermined use verification term is below a predetermined use threshold.

6. The method of claim 1, further comprising identifying and removing from the memory a conflicting binding involving at least one of the outlet or the appliance.

7. The method of claim 1, wherein the step of taking action comprises selecting an administrative action from a plurality of candidate administrative actions based on a severity of a deviation of the monitored power draw from a power profile for the appliance.

8. The method of claim 1, wherein the method further comprises verifying that the administrative action is not redundant before taking the action.

9. The method of claim 1, wherein the configuring step comprises detecting connectivity of the appliance to the outlet; querying the appliance through the outlet for a media access control (MAC) address of the appliance; and associating in the memory an identifier of the outlet and the MAC address.

10. The method of claim 1, wherein the configuring step comprises receiving an association between an identifier of the outlet and an Internet Protocol (IP) address of the appliance; querying the appliance on a TCP/IP network using the IP address for a MAC address of the appliance; receiving from the appliance on the TCP/IP network the MAC address; and associating in the memory the identifier of the outlet and the MAC address.

11. The method of claim 1, wherein the inventory management action comprises a procurement action.

12. The method of claim 1, wherein the inventory management action comprises a replacement action.

13. The method of claim 1, wherein the inventory management action comprises a redeployment action.

14. The method of claim 1, wherein the inventory management action comprises a security action.

15. The method of claim 1, wherein the administrative action comprises scheduling an event.

16. The method of claim 1, wherein the administrative action comprises outputting an alert.

17. A system for administering enterprise appliances, comprising:
a status and control unit having a power outlet; and
a power manager communicatively coupled with the status and control unit and having an associated memory, wherein the status and control unit and the power manager are configured to interoperate to monitor a power draw on the outlet over time, and wherein the power manager is further configured to detect an anomaly in the power draw, associate the anomaly with an enterprise appliance by reference to a binding between the outlet and the appliance configured in the memory and take administrative action respecting the appliance in response to the anomaly.

18. The system of claim 17, wherein the power manager is configured to take a maintenance action respecting the appliance in response to determining that the monitored power draw deviates from a power profile for the appliance during a predetermined short term and take an inventory management action respecting the appliance in response to determining that the monitored power draw deviates from the power profile during a predetermined long term.

19. The system of claim 17, wherein the power manager is configured to take an inventory management action respecting the appliance in response to determining that the monitored power draw persists below a predetermined in-service threshold for a predetermined service verification term.

20. The system of claim 17, wherein the power manager is configured to take an inventory management action respecting the appliance in response to determining that an amount of time the monitored power draw is above a predetermined in-service threshold during a predetermined use verification term is below a predetermined use threshold.
